(19) United States
(12) Patent Application Publication
(10) Pub. No.: US 2009/0039610 A1
(43) Pub. Date: Feb. 12, 2009

(54) Suspension for a tracked vehicle

(76) Inventor: Gerard John Karpik, Eveleth, MN (US)

Correspondence Address: Gerard J Karpik, 8151 Long Lake Court East, Eveleth, MN, 55734, US

(21) Appl. No.: 12/221,238

(22) Filed: Jul. 31, 2008

Related U.S. Application Data
(60) Provisional application No. 60/962,952, filed on Jul. 31, 2007.

(51) Int. Cl. B62D 55/112

(52) U.S. Cl. 280/124.129

(57) ABSTRACT

A simple and cost effective air sprung suspension for tracked vehicles. The apparatus having at least one suspension arm, a track guiding means that include a pair of slide rails, a set of carrier wheels and a set of rear wheels. An air spring biasing mechanism and a shock absorber are mounted along side each other and within the space between the two slide rails. The new mounting arrangement provides for both a simple and cost effective technique of obtaining individual rates of displacement for the shock and air spring. The separately optimized rates of displacements cause the air spring and shock absorber to operate more effectively as a system in delivering greater comfort and increased separation for the occupants from the often rough and varied terrain a tracked vehicle encounters.

### FIELD OF THE INVENTION

This invention relates to tracked vehicle suspensions, and more particularly, to a new simple, cost effective, light and improved suspension of an endless drive track of a snowmobile that provides improved vehicle control and comfort of humans using the vehicle over a wide range of terrain from smooth to rough holed and mounded areas of snow and ice and a wide range of speeds and when cornering.

### BACKGROUND OF THE INVENTION

Snowmobiling is a popular recreational activity in areas which receive snow during the winter. Local trail systems have been developed in areas in which snowmobiling is popular. It is not uncommon for a snowmobiler to cover one hundred (100) miles in a single outing. Unfortunately, it is also not uncommon for snowmobile trails to be in rough condition due to the volume of snowmobile traffic on weekends and other times when a large number of snowmobilers are using the trail. The trail conditions encountered by a snowmobiler can vary from a freshly groomed trail to sections of small washboard bumps to sections of very large bumps. The snowmobiler may also cross roads, cross icy lakes, or venture off the trail into powder snow all in a single excursion.

In order to fully enjoy the sport of snowmobiling, snowmobilers require a snowmobile suspension which gives them good ride quality and good control of the snowmobile. Ideally, this suspension mechanism should be light, affordable and capable of isolating the occupants from a wide range of conditions including small through large bumps and a wide variety of speeds. Because snowmobile suspension mechanisms are subjected to repeated shocks and intense vibration along with exposure to water, ice, snow, salt and dirt, it is important that snowmobile suspension mechanisms be very durable.

As in other forms of motorized vehicles it has proven effective to replace the biasing function of metal springs with lower frequency air springs as a means of obtaining an improvement in ride quality for the vehicles occupants.

U.S. Pat. No. 3,863,727 (Michrina) discloses such a system employing an air spring that is centrally mounted between a pair of slide rails. The patent teaches of the location of the single air spring being unattached and far ahead of the rear suspension arm where the majority of forces will enter the vehicle. This leaves the chassis and riders exposed to high forces when the vehicle is jumped and lands solely on the suspension tail. By design the system uses two very separate mounting locations for the air spring and shock absorber which increases the complexity, weight and cost of the suspension.

U.S. Pat. No. 6,502,651 ((Zaczkowski) also discloses a system employing an air spring that is centrally mounted between a pair of slide rails and use a complex multi piece linkage mechanism to obtain sufficient displacement of the shock absorber. It is arranged to deliver a largely linear or slightly rising rate motion ratio curve that is less than optimum in delivering isolation and comfort to the rider when coupled to the naturally rising rate of an air spring. This system uses two separate and complex mechanism to attempt to achieve what can be accomplished with a much simpler, lighter and cost effective system.

U.S. Pat. No. 4,826,260 ((Plourde) discloses mounting system with the air spring being packaged around the components of it's shock absorber. This is an example of a clean and light mounting system but the length ratios of the active suspension arms about their axis leave the biasing and damping forces as highly leveraged requiring much greater static pressures and damping forces which will result in higher than desirable levels of friction between the suspensions rotationally moving components and their axis components. This friction will cause the suspension to be less responsive than a more direct approach to delivering biasing and damping forces to the slide rail. The air spring's displacement is also restricted in total amount as a result of being directly tied to the limited displacement a shock absorber can attain as compared to an independently mounted air spring.

U.S. Pat. No. 4,826,260 (Lillbacka et al.) also teaches of centrally mounted air spring and the air spring being packaged around the components of it's shock absorber. In this system the air spring's displacement is restricted in total amount as a result of being directly tied to the limited displacement a shock absorber. In best practice, a typical shock absorber of the sliding piston type can only deliver a useable amount of travel that is roughly equal to its:

(Extended length/2)−(its dead length) in practice on a 14.25″ long shock this is: (14.25″/2)−(2.5″)=4.625″

This limited displacement will not be sufficient to deliver the extra comfort that an air spring that uses its entire effective displacement within a suspension system does.

What is needed is a system that provides for maximizing the air springs extremely efficient displacement versus overall component length ratio, while at the same time being simple cost effective, light and geometrically arranged to deliver an increase in comfort throughout the varied terrain a track vehicle must operate in.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of the suspension assembly of the subject invention;

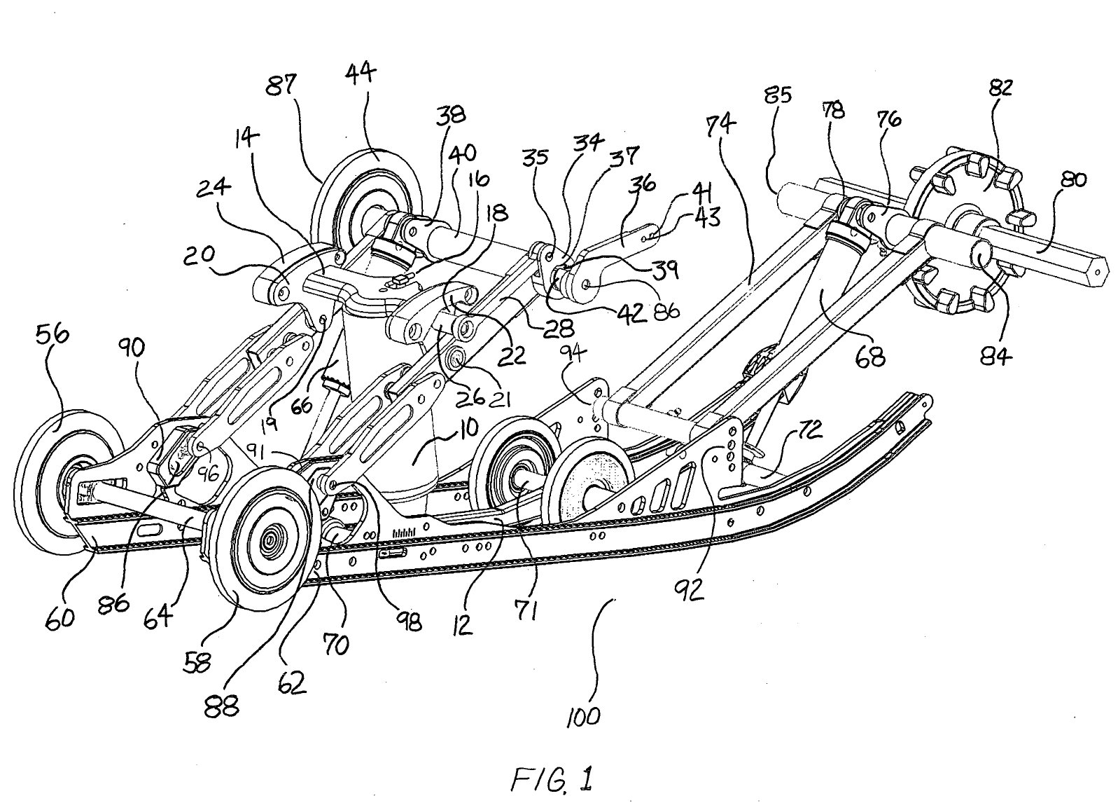

FIG. 2 is a side view of the suspension assembly;

FIG. 3 is a top view of the suspension assembly;

FIG. 4 is a side view of the suspension assembly located within the rear portion of a snowmobile chassis.

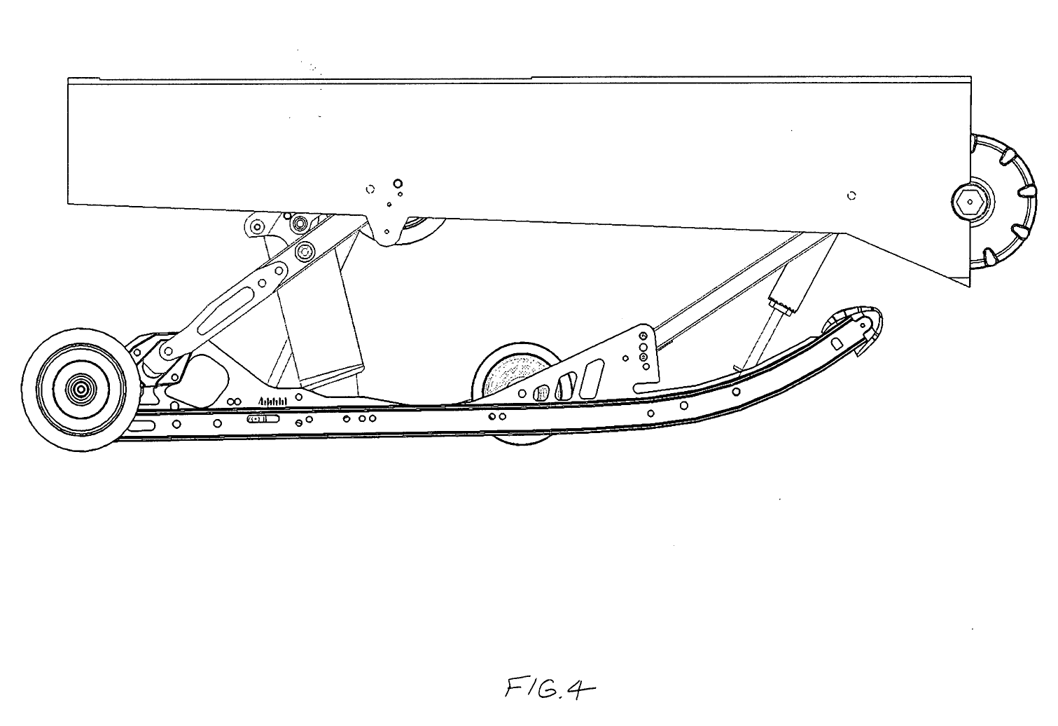

### BRIEF SUMMARY OF THE INVENTION

The present invention relates generally to suspension mechanisms for tracked vehicles. More particularly, the present invention relates to a simple, light and cost effective and new side by side arrangement of a shock and air spring between the slide rails of the subject suspension. It is also teaches of the complimentary use of the opposite effects of the naturally rising force curve available with an air spring with the naturally falling force curve of a shock absorber mounted in a falling rate geometric design, i.e., as the suspension movement increase the shock absorber movement decreases in it relative movement to jounce displacement.

The present invention is directed to a suspension mechanism for a snowmobile comprising a pair of elongated slide rails connected together by a plurality of supports to define a slide rail frame. At least one suspension mechanism is attached to the slide rail frame which includes an air spring. The suspension mechanism includes an air spring having a first end and second end, the first end of said air spring being rotationally connected to the chassis of the snowmobile through an upper mount that is rotationally connected to a suspension arm. The second end of the air spring mounted to a lower air spring mount. The upper mount is designed such that the pivot points of the mount are located below the point at which the air spring is connected to the mount. This mounting structure allows the mount to rotate to accommodate changes in the angular orientation of the air spring.

A snowmobile in accordance with the present invention includes a seat to accommodate a snowmobile operator, a steering arrangement, and a control panel. In a presently preferred embodiment, both the steering arrangement and the control panel are located where they will be easily accessible to the snowmobile operator. The major components of snowmobile include; a pair of skis each having a ski suspension mechanism, a hood, a track, a chassis, and a rear suspension.

In a presently preferred embodiment, the rear suspension includes a slide rail frame, which supports the track along its length. The slide frame includes a left slide and a right slide which are connected by a plurality of cross members. The left slide and the right slide are also connected by a rear axle which supports a plurality of idler wheels. A plurality of bogie wheels may also be rotationally attached to slide frame.

In a presently preferred embodiment, one or more the subject suspension mechanisms is attached to the slide frame. A suspension mechanism in accordance with the present invention comprises a suspension arm which is adapted to be rotationally coupled to the chassis of a snowmobile proximate a first end of the suspension arm. The second end of the suspension arm may be attached directly to the slide rails or may be attached indirectly to the slide rail through a lost motion device known as the coupler block mechanism as described in U.S. Pat. No. 5,370,198. Other embodiments may use other linking devices that are effectively linking bars between the second end of the suspension arm and the slide rails.

The suspension mechanism also includes an air spring having a first end and a second end. The air spring is used to bias the slide rails away from the chassis. The first end of air spring has an internal access mechanism that can be used to attach a Schrader type valve or a filler hose. The first end of the air spring is seated against an upper air spring mount which is rotationally coupled to the suspension arm through side plates that have pivot points and may have track carrier guides as in the preferred embodiment. The side plates are rotationally connected to a link by means of an offset bushing. The link is rotationally connected to the upper cross shaft of the suspension arm by means of a clevis pin and the link bracket. The link bracket is fixed in relation to the cross shaft by a press fit and or a locking device means such as the matching set of flat in the preferred embodiment or other locking mechanism.

The cross shaft which locates the first end of the suspension arm is fixed to the chassis at both endpoints by bolting means and is further affixed non-rotationally to the chassis. This function is provided by the shaft lock in the preferred embodiment which has matching locking flats with the cross shaft. The shaft lock is also fixed to the chassis by mechanical means such as being bolted to the chassis at a second mounting location. The second end of the air spring is located against the longitudinally positioned lower air spring mount which is attached on one end to the slide rails by the rear lower shock shaft that is bolted to the slide rails. The other end of the lower air spring mount is attached by a forward wheel shaft which is bolted to the rails.

The track which is not shown, runs in part around portions of the circumferences of carrier wheels and a plurality of rear wheels that are supported by a rear axle and one or more of the drive wheels and the bearing surfaces of slide rails which are often known as hyphax and are generally made from synthetic or plastic material and are not shown.

The shock absorber is rotationally attached to the arm assembly by means of a bearing and shock tabs. The other end of shock absorber is rotationally attached by means of a bearing to the shock shaft.

As shown in the preferred embodiment a second shock absorber is rotationally connected to the slide rails by means of front shock shaft. It is rotationally attached to a front arm assembly by means of bearings and shock tabs. The preferred embodiment is shown without a front spring mechanism and can be used that way in addition it is also possible to arrange without the front shock absorber. The drive for the track is provided by means of a drive axle which is coupled to at least one drive wheel and a power supply.

### DETAILED DESCRIPTION OF THE PREFERRED EMBODIMENT

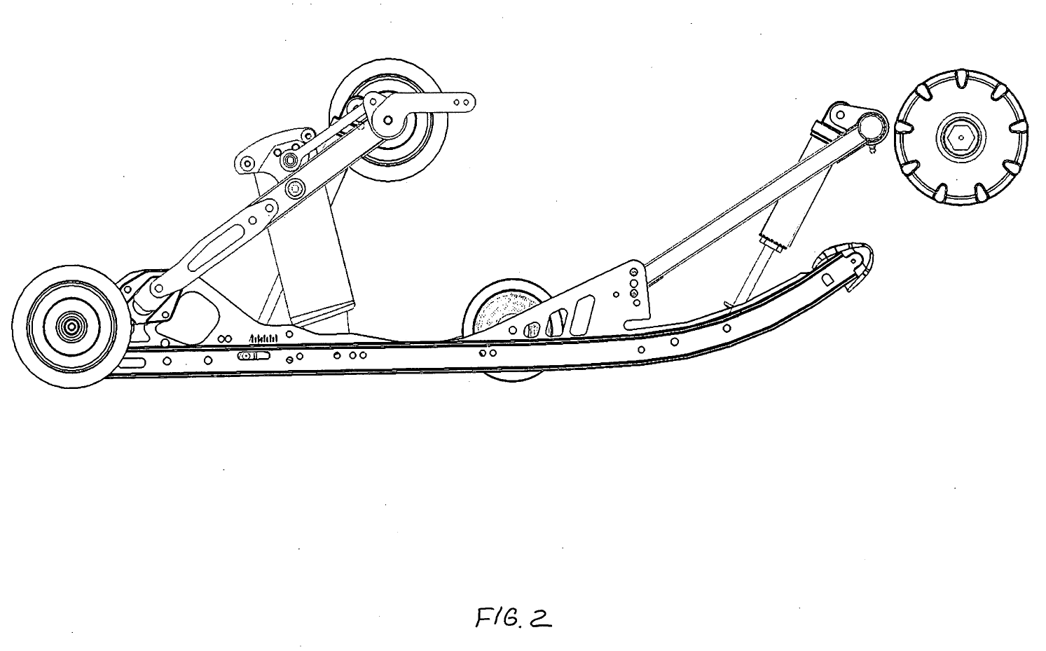

FIG. 2 is a side view of the suspension which illustrates the new, simple, light and cost effective system that is achieved by packaging an air spring and shock absorber alongside each other rather than in line with each other.

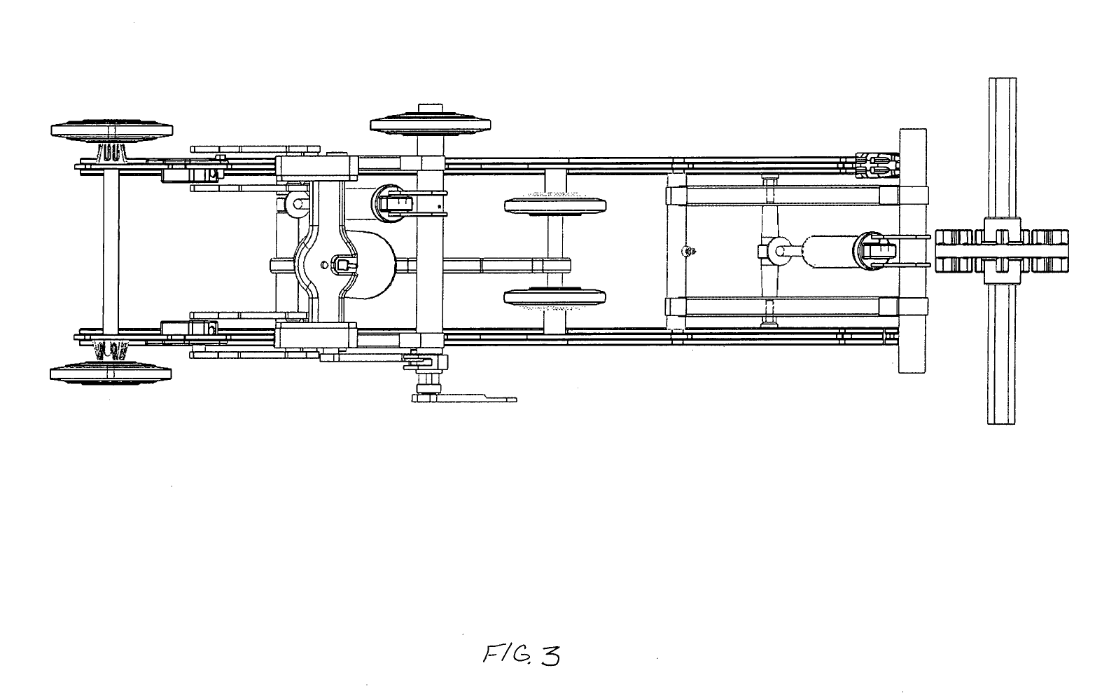

Turning now in greater detail to FIG. 3 the subject suspension is shown in a perspective view. Some components such as nuts, bolts and items with bearing surfaces of the suspension 100 have been left out for clarity. In the exemplary suspension a pair of slide rails 60 and 62, are connected to the snowmobile chassis which is not shown through a front arm assembly 74 and suspension arm assembly 40. The front arm rotationally attaches to the slide rails 60 and 62 at the pivot points 92 and 94. Front arm assembly 74 is rotationally attached to the snowmobile chassis which is not shown at axis points 84 and 85.

The arm assembly 40 which is rotationally mounted to the chassis by means of cross shaft 42 is shown as a composite of steel and aluminum pieces and attaches to the rails 60 and 62 indirectly through sliding coupler blocks 86 and 88. The rear arm assembly is rotationally mounted to the coupler blocks 86 and 88 at pivot locations 96 and 98. The coupler blocks 86 and 88 are allowed to slide within a defined space of slider block housings 90 and 91 which are fixed to rails 60 and 62.

The air spring 10 which is used to bias the slide rail away from the chassis is indirectly attached on one end to the slide rails through the longitudinally positioned lower mount 12. Lower mount 12 is attached to the rails by rear lower shock shaft 70 which is bolted to rails 60 and 62 and wheel shaft 71 which is bolted to rails 60 and 62 and the accompanying spacers for both shafts. On the other end the air spring 10 is attached to the upper mount 14. The air spring 10 has an internal access mechanism at point 16 which can be used to mount a Schrader valve or filler hose neither are shown. The upper mount 14, is rotationally coupled to the arm assembly 40 through the side plates 18 and 20 at pivot points 19 and 21 and in the preferred embodiment have track carrier guides 22 and 24 which in some applications will not be needed. Side plate 18 is rotationally connected to link 28 by means of offset bushing 26. Link 28 is rotationally connected to the upper rear cross shaft 42 by means of a clevis pin 35 through the link bracket 34. Bracket 34 is fixed in relation to the cross shaft by a press fit and a bracket flat 37 which fits against the cross shaft flat 39. Cross shaft 42 is fixed to the chassis at points 86 and 87 which is not visible in this drawing. Cross shaft 42 is further fixed to the chassis by means of the shaft lock 36 which also has matching flats with the cross shaft 42, which is fixed to the chassis by mechanical means such as being bolted to the chassis through other points 41 and 43. The track which is not shown, runs in part around portions of the circumferences of carrier wheels 44 and its matching wheel for the right hand sign which is not shown for clarity and at least one rear wheel or as in this case two rear wheels 56 and 58 that are supported by rear axle 64 and one or more of the drive wheel 82 and the bearing surfaces of slide rails 60 and 62 which are often known as hyphax and are generally made from plastic material and are not shown. The shock absorber 66 is rotationally attached to the suspension arm assembly 40 by means of a bearing and shock tabs 38 and 39. The other end of shock absorber 66 is rotationally attached by means of bearing to shock shaft 70. The suspension is shown without a front spring mechanism and can be used that way. The front shock absorber 68 is rotationally connected to the slide rails 60 and 62 by means of front shock shaft 72, it is rotationally attached to the front arm assembly by means of bearings and shock tabs 76 and 78. The drive for the track which is not shown is provided by means of drive axle 80 which is coupled to a power supply and drive wheel 82.

Now turning in greater detail to the biasing forces generated by the air spring 10 used to isolate the vehicle and occupants from the varied terrain of a tracked vehicle and the rising rate nature of the force curve of air spring 10. It is well known those in the art of suspension design that a naturally rising force curve cab be obtained from a properly design air spring such as the Firestone air spring #7065 with plastic piston that is employed in the exemplary suspension design. This spring which is approximately 11″ long gets compressed to a length of approximately 3.5″ long at end of jounce travel. This large change in volumes causes the pressure inside the air spring to rise sharply at the end of travel while remaining relatively low throughout the initial stages. This sharp rise in pressure results in a progressive rise in the force curve obtained from air spring 10. The relatively low pressure in air spring 10 during the initial stages of jounce travel deliver the occupants a more supple ride from the suspension 100, while the sharp rise in pressure during the later stages toward the end of travel delivers the occupants increased isolation from high energy jounce event such as large and higher speed bumps.

The rising rate nature of the compression force curve obtained from the air spring 10 allow for the shock absorber 66 to mounted in a simple, light and inexpensive and falling rate geometry without requiring the need for sophisticated, heavy and expensive spring strategies such as those employed by FAST Inc of Eveleth Minnesota in their M-10 suspensions to resist bottoming in big bumps and in particular bumps that have high gravitational force with low shock absorber shaft speeds.

The nature of the falling rate shock absorber geometry i.e., as the suspension movement increases the shock absorber 66 movement decreases in it relative movement to jounce displacement is actually a significantly beneficial to the occupant comfort. In most small to medium bump events the shaft speeds of shock absorber is relatively low unless the bump is particularly sharply edged in shape. With low shaft speed shock absorber 66 develops little resistance generated by its displacement and the progressively falling shape of the force curve of shock absorber 66 allows the suspension to move significantly more in lower energy events. When coupled with the lower initial pressures developed in the air spring a very comfortable ride is obtained by the occupants.

As the shaft speed of shock absorber 66 increases with sharper shaped and medium sized bumps the shaft speed of shock absorber 66 increases and results in greater resistance than those bumps that cause lower shock absorber shaft speeds. The higher energy these bumps develop causes the suspension to displace large amounts as well, which isolates the rider well as long as the suspension does not bottom and is displacement isn't too fast. The damping forces developed in the falling rate geometry are sufficient enough to prevent these events from happening.

Eventually the size, shape and speed at which bumps are encountered will overcome the damping capacity of the shock absorber and the capability of it to resist bottoming. At this point the suspension 100 is quite deep into jounce travel and has displaced the air spring 10 significantly and the sharp rise in pressure inside the air spring 10 stops the suspension 100 from bottoming and results in limiting most major forces from being imparted to the occupants during large energy bumps events.

At this point in a bump event the biasing forces from the air spring 10 are at or near their highest level. This then forces the suspension 100 to go into rebound travel which is the opposite of compression travel in that it is a rising rate displacement i.e., as the suspension movement increases the shock absorber 66 movement increases in it relative movement to rebound displacement. The result is an increasing rate of shock absorber 66 shaft speed on rebound travel as opposed the reducing rate of shock absorber shaft speeds in most modem suspensions. The increasing rate of shock absorber shaft speed has a much larger resistance to the extremely common and aggravating trait in traditional suspensions of kicking back the chassis and seat into the rider after encountering high energy bump events.

The other noted advantage of the rising rate displacement in rebound travel of the exemplary suspension 100 is that with lower shock absorber 66 shaft speeds at the end of travel there is little resistance to rebound travel away from a full or nearly full jounce events. This allows the suspension to extend itself so that it is in position of enough extension to absorb a next bump event.

1. An air sprung suspension for suspending a tracked vehicle and occupants while vehicle traverses bumpy terrain, said assembly comprising: slide rails having a forward end and a rearward end, and a generally linear track bearing surface; at least one suspension arm having an upper end adapted for rotational connection to said tracked vehicle chassis and a lower end rotationally connected to said slide rails; an air spring having a first end mounted to an upper air spring mount and a second end mounted to a lower air spring mount, a shock absorber having a first end mounted to an upper mount and second end mounted to a lower shock absorber mount; said air spring and said shock absorber being mounted on opposing sides of the longitudinal centerline of said suspension and disposed between said slide rails of said suspension, said shock absorber and said air spring being mounted along side each other, said shock absorber and said air spring for controlling movement of said slide rails moving towards and away from said upper end of said suspension arm in response to upward and downward forces imposed on said slide rails.

2. An assembly as set forth in claim 1 wherein said air spring includes a piston which is fabricated from a synthetic material.

3. An assembly as set forth in claim 1 wherein said lower air spring mount is disposed parallel to the longitudinal centerline of said suspension.

4. An air sprung suspension for suspending a tracked vehicle and occupants while traversing bumpy terrain, said assembly utilizing a geometric arrangement between an air spring and a shock absorber such that as the suspension movement increases the shock absorber movement decreases in relative movement to jounce displacement and that as the suspension movement increases the air spring movement remains largely uniform throughout its relative movement to jounce displacement.

5. An assembly as set forth in claim 4 wherein said air spring includes a piston which is fabricated from a synthetic material.

6. An assembly as set forth in claim 4 wherein said lower air spring mount is disposed parallel to the longitudinal centerline of said suspension

7. An air sprung suspension for suspending a tracked vehicle and occupants while traversing bump terrain, said assembly utilizing a geometric arrangement between an air spring and a shock absorber such that as the suspension movement increases the shock absorber movement increases in relative movement to rebound displacement and that as the suspension movement increases the air spring movement remains largely uniform throughout its relative movement to jounce displacement.
